(19) United States
(12) Patent Application Publication
(10) Pub. No.: US 2008/0313007 A1
(43) Pub. Date: Dec. 18, 2008

(54) METHODS AND APPARATUS FOR SCHEDULING AN IN-HOME APPLIANCE REPAIR SERVICE

(75) Inventors: Kevin Callahan, Crystal Lake, IL (US); Daryle Gibbens, Leander, TX (US)

Correspondence Address: GREENBERG TRAURIG, LLP, 77 WEST WACKER DRIVE, SUITE 2500, CHICAGO, IL, 60601-1732, US

(73) Assignee: SEARS BRANDS, L.L.C., Hoffman Estates, IL (US)

(21) Appl. No.: 12/169,293

(22) Filed: Jul. 8, 2008

Related U.S. Application Data
(63) Continuation of application No. 09/778,311, filed on Feb. 7, 2001, now abandoned.

(51) Int. Cl. G06Q 10/00; G06Q 50/00

(52) U.S. Cl. 705/9

(57) ABSTRACT

A system for scheduling an in-home appliance repair service is disclosed. The system receives inputs from a user via a client device. The inputs are used to identify one or more home appliances in need of repair. For example, the user may have a clogged dishwasher. Data identifying the appliance is then transmitted to a repair scheduling server. The repair scheduling server executes a program which determines a plurality of available repair time slots and transmits a list of choices to the client device for display. The available repair time slots may depend on the type of appliance, the brand of the appliance, the particular model, the user's identify, and/or the geographical location of the appliance. Preferably, time slots are dynamically determined in cooperation with a plurality of service providers. Once the user selects a timeslot, the service is confirmed and scheduled.

### RELATED APPLICATION INFORMATION

This application is a continuation of and claims the benefit of U.S. application Ser. No. 09/778,311 filed on Feb. 7, 2001.

### TECHNICAL FIELD

The present invention relates in general to scheduling services via a network and, in particular, to methods and apparatus for scheduling an in-home appliance repair service.

### BACKGROUND

Often, home appliances require regular maintenance and/or repair. Typically, consumers refer to a phone directory and call one or more repair services in order to locate a particular service provider who is familiar with the specific make and model in need of repair and to determine a mutually agreeable time during which to schedule an in-home visit to perform the repair.

However, this process is cumbersome. Typically, the consumer must wait until regular business hours to make the phone calls. Often, the consumer must make several phone calls and/or be transferred multiple times in order to locate a service provider familiar with his specific repair need. In addition, the times during which a single service provider may schedule an appointment may be limited.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a network communications system employing an embodiment of the present invention.

FIG. 2 is a more detailed block diagram of one of the client devices illustrated in FIG.

FIG. 3 is a more detailed block diagram showing one embodiment of the repair scheduling server illustrated in FIG. 1.

FIG. 4 is a more detailed block diagram showing another embodiment of the repair scheduling server illustrated in FIG. 1.

FIGS. 5-6 are a flowchart of a process for scheduling an in-home appliance repair service.

FIG. 7 is a screen-shot of an exemplary web page used to request scheduling of an in-home appliance repair service.

FIGS. 8-11 are a series of screen-shots of an exemplary web page used to identify an appliance in need of repair and to identify a general geographic location.

FIGS. 12-14 are a series of screen-shots of exemplary web pages used to help a customer determine his/her appliance model number.

FIG. 15 is a screen-shot of a completed exemplary web page used to identify an appliance in need of repair and to identify a general geographic location.

FIG. 16 is a screen-shot of a exemplary web page used to display and select an available repair time slot.

FIG. 17 is a screen-shot of an exemplary web page used to identify a specific geographic location and other customer contact information.

FIGS. 18-26 are a series of screen-shots of an exemplary web page used to help a customer use the appliance repair scheduling service.

### DETAILED DESCRIPTION OF EXEMPLARY EMBODIMENTS

In general, the system described herein allows a user to schedule an in-home appliance repair service via a network such as the Internet. The system receives inputs from a user via a client device. The inputs are used to identify one or more home appliances in need of repair. For example, the user may have a clogged dishwasher. Data identifying the appliance is then transmitted to a repair scheduling server. The repair scheduling server executes a program which determines a plurality of available repair time slots and transmits a list of choices to the client device for display. The available repair time slots may depend on the type of appliance, the brand of the appliance, the particular model, the user's identify, and/or the geographical location of the appliance. Preferably, time slots are dynamically determined in cooperation with a plurality of service providers. Once the user selects a timeslot, the service is confirmed and scheduled. In addition, a person of ordinary skill in the art will readily appreciate that the teachings described herein may be used in conjunction with the delivery and/or installation of an appliance purchased online.

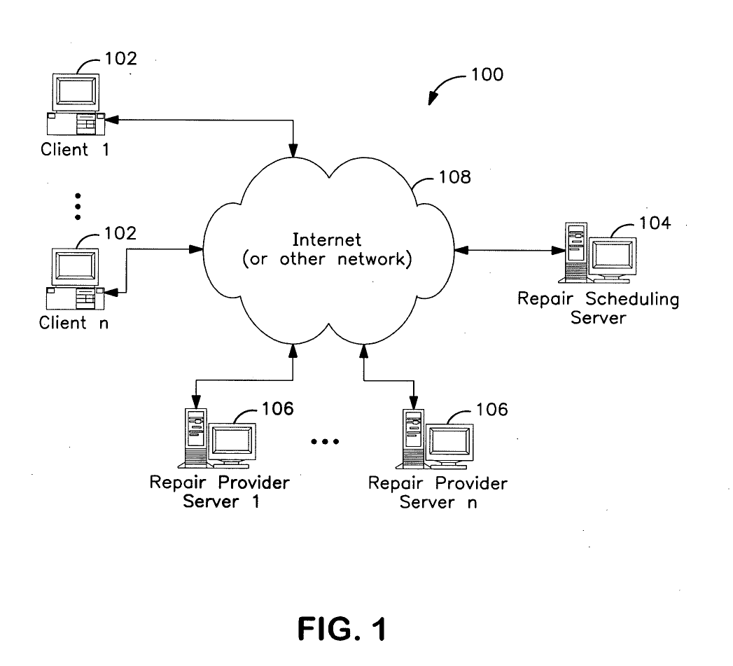

A high level block diagram of an exemplary network communications system 100 capable of employing the teachings of the present invention is illustrated in FIG. 1. Typically, the system 100 includes one or more client devices 102, one or more repair scheduling servers 104, and one or more repair provider servers 106. Each of these devices may communicate with each other via a connection to the Internet or some other wide area network 108.

Typically, repair scheduling servers 104 store a plurality of files, programs, and/or web pages for use by the client devices 102 and/or the repair provider servers 106. One scheduling server 104 may handle requests from a large number of clients 102. Accordingly, each server 104 is typically a high end computer with a large storage capacity, one or more fast microprocessors, and one or more high speed network connections. Conversely, relative to a typical server 104, each client device 102 typically includes less storage capacity, a single microprocessor, and a single network connection.

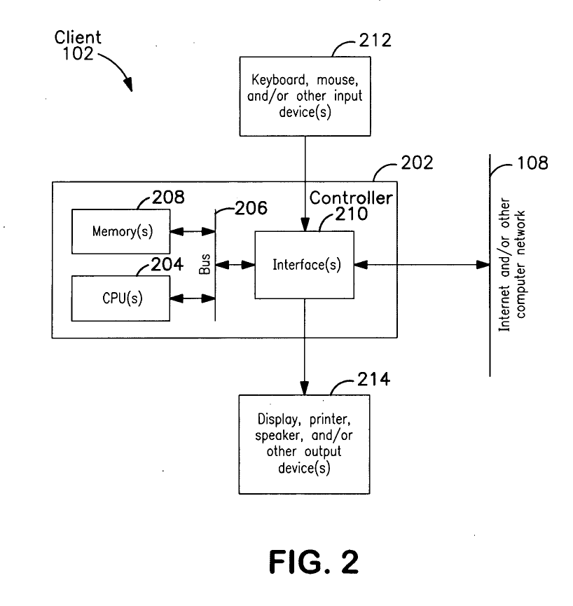

A more detailed block diagram of a client device 102 is illustrated in FIG. 2. The client device may be a personal computer (PC), a personal digital assistant (PDA), an Internet appliance, a cellular telephone, or any other communication device. The client 102 includes a controller 202 which preferably includes a central processing unit 204 electrically coupled by an address/data bus 206 to a memory device 208 and an interface circuit 210. The CPU 204 may be any type of well known CPU, such as an Intel Pentium.™. processor. The memory device 208 preferably includes volatile memory and non-volatile memory. Preferably, the memory device 208 stores a software program that interacts with the repair scheduling server 104 as described below. This program may be executed by the CPU 204 in a well known manner. The memory device 208 may also store digital data indicative of documents, files, programs, web pages, etc. retrieved from a server 104, 106 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, speakers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the client 102. The display 214 is typically used to display web pages received from the repair scheduling server 104. The visual displays may include prompts for human operator input, run time statistics, calculated values, detected data, etc.

The client 102 may also exchange data with other devices via a connection to the network 108. The network connection may be any type of network connection, such as an Ethernet connection, digital subscriber line (DSL), telephone line, coaxial cable, etc. Users of the system 100 may be required to register with the repair scheduling server 104. In such an instance, each user may choose a user identifier and a password which may be required for the activation of services. The user identifier and password may be passed across the Internet 108 using encryption built into the user's browser. Alternatively, the user identifier and/or password may be assigned by the repair scheduling server 104.

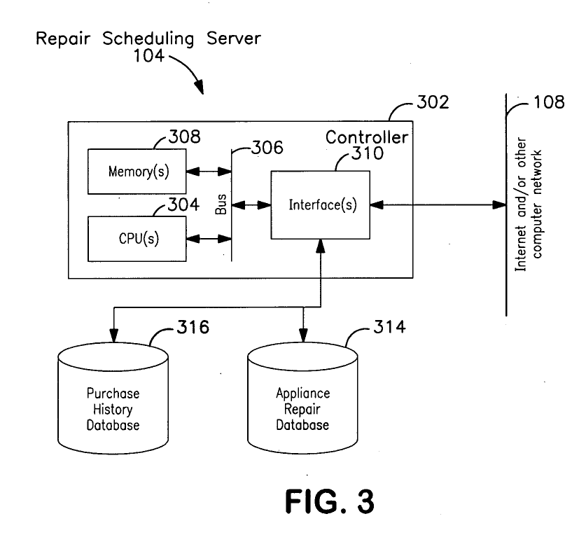

A more detailed block diagram of a repair scheduling server 104 is illustrated in FIG. 3. Like the client device 102, the controller 302 in the server 104 preferably includes a central processing unit 304 electrically coupled by an address/data bus 306 to a memory device 308 and a network interface circuit 310. However, the sever controller 302 is typically more powerful than the client controller 202. Again, the CPU 304 may be any type of well known CPU, such as an Intel Pentium™ processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or one or more separate databases 314, 316 also store files, programs, web pages, etc. for use by servers 104, 106 and/or the client devices 102.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

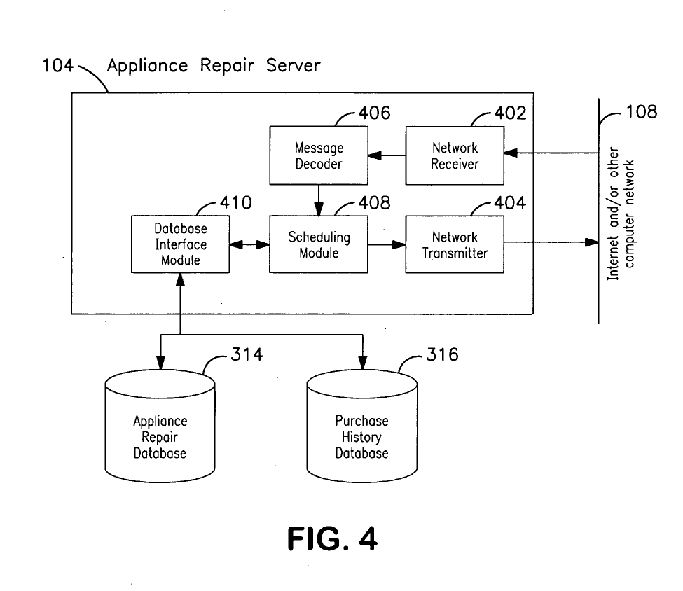

A more detailed block diagram of another embodiment of the repair scheduling server 104 is illustrated in FIG. 4. In this embodiment, the repair scheduling server 104 includes a plurality of interconnected modules 402-410. Each of the modules may be implemented by a microprocessor executing software instructions and/or conventional electronic circuitry. In addition, a person of ordinary skill in the art will readily appreciate that certain modules may be combined or divided according to customary design constraints.

For the purpose of receiving and decoding web page requests, purchase requests, appliance selection requests, appliance identifiers, geographical identifiers, user identifiers, time slot selection data, schedule data, and other data from client devices 102 via the wide area network 108, the repair scheduling server 104 includes a network receiver 402 and a message decoder 406. The network receiver 402 is operatively coupled to the network 108 in a well know manner. For example, the network receiver 402 may be an Ethernet interface circuit electrically coupled to the Internet via an Ethernet cable. Preferably, the message decoder 406 is operatively coupled to the network receiver 402 and a scheduling module 408. The message decoder preferably decodes the above listed message according to a network protocol such as the Hypertext Transport Protocol (HTTP).

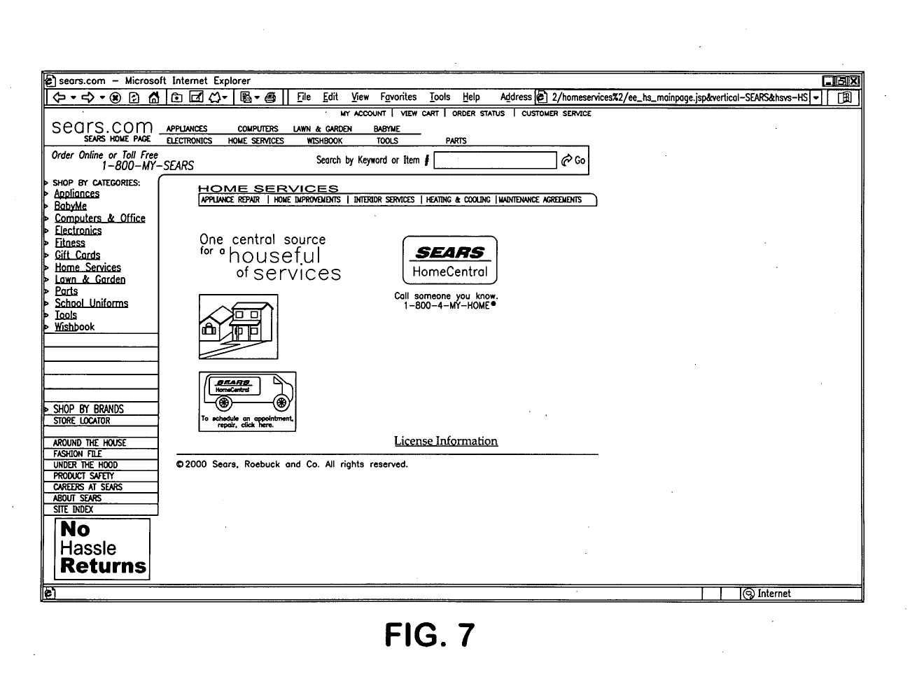

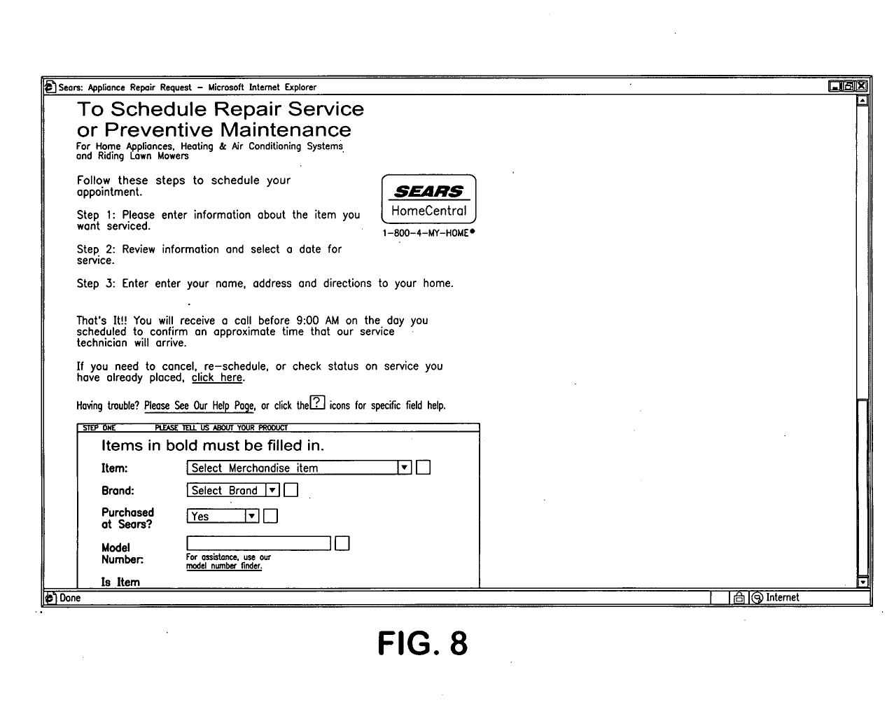

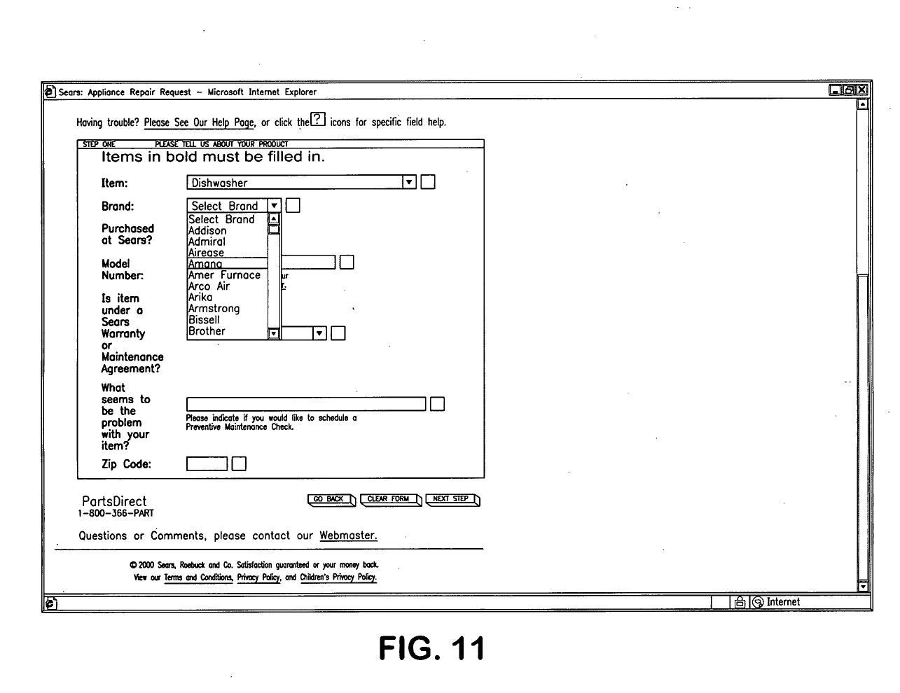

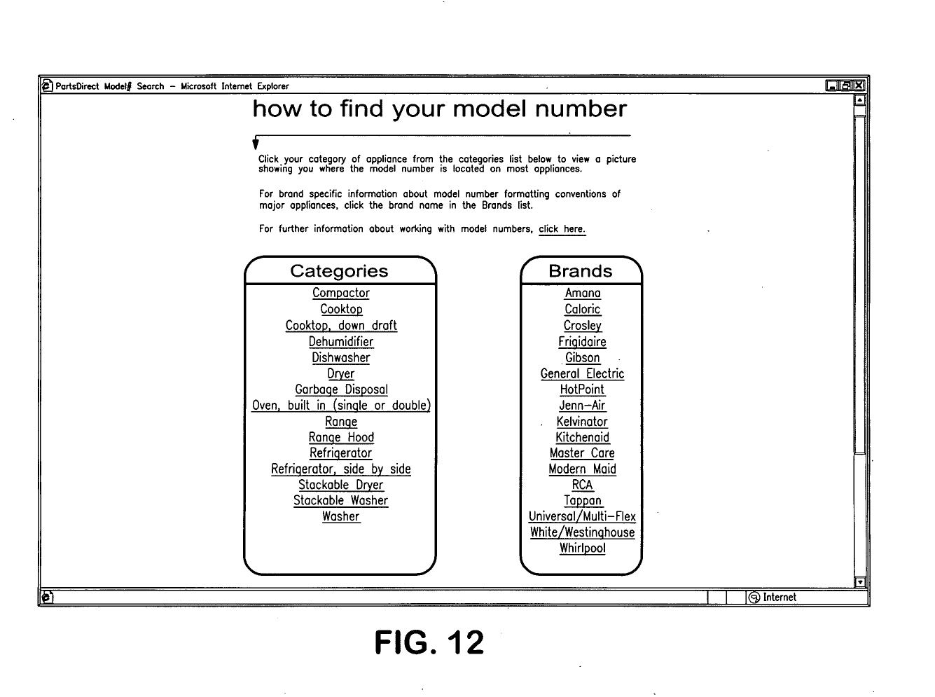

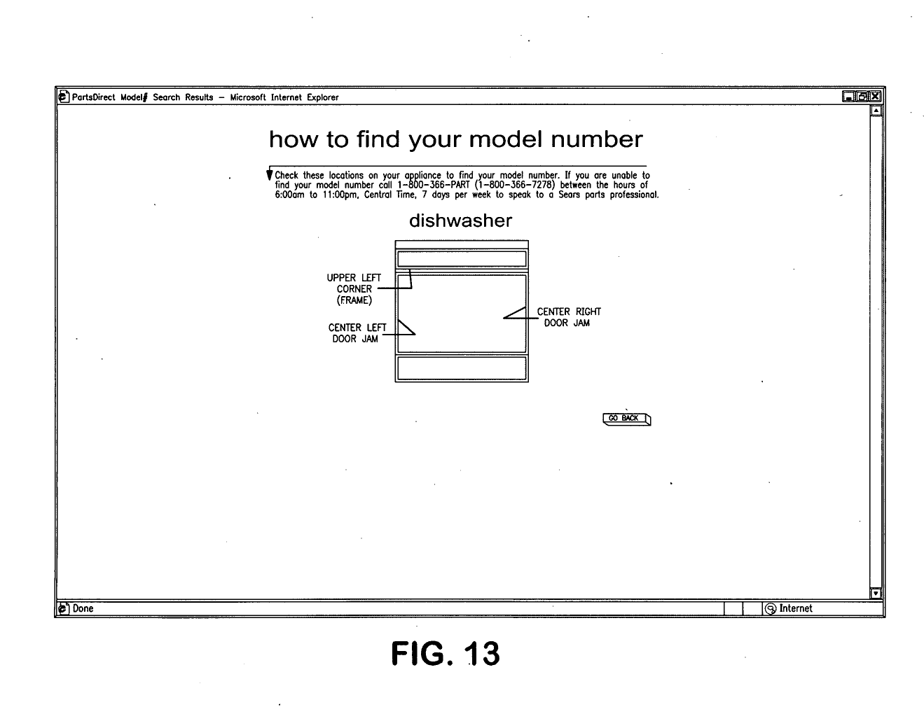

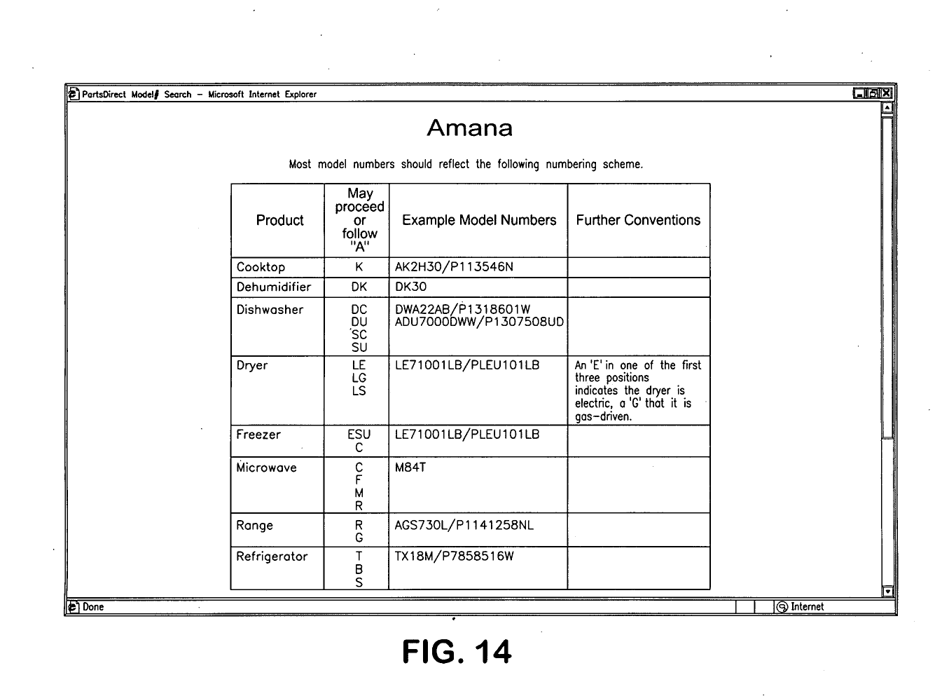

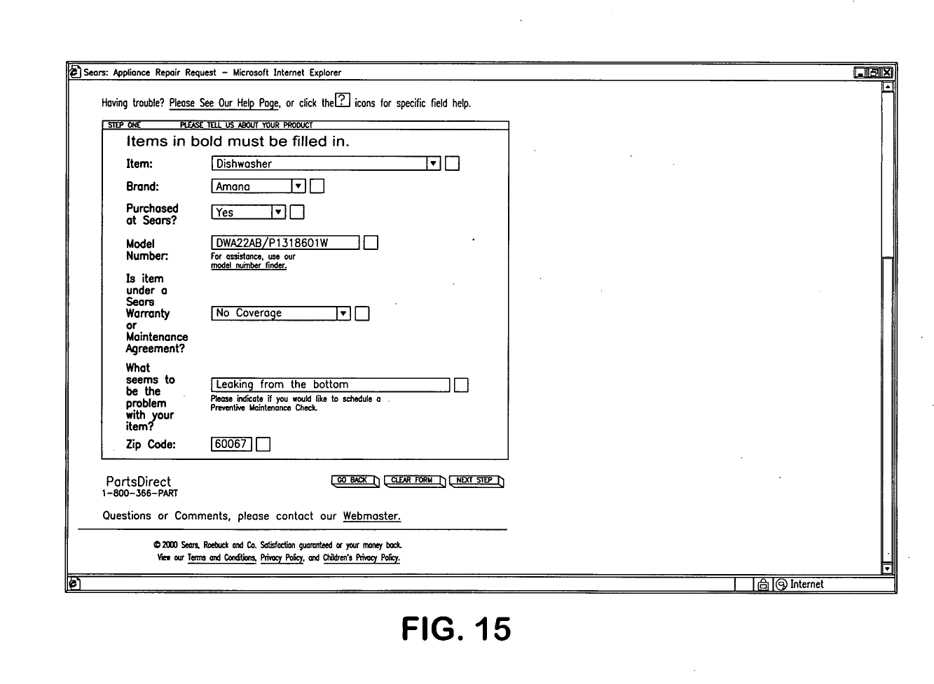

Preferably, an appliance selection request is indicative of a desire to receive appliance selection data. Appliance selection data helps the user identify a home appliance which is in need of repair to the repair scheduling server 104. For example, the appliance selection request may come in the form of a hypertext transport protocol (HTTP) message requesting a web page which facilitates the entering of an appliance identifier into an input box and/or the selection of an appliance identifier from a displayed list. See FIGS. 7-15. An appliance identifier distinguishes one home appliance from another home appliance. The appliance identifier may be any identifier such as a model number, model name, serial number, etc.

A geographical identifier distinguishes one physical location from another physical location. The geographical identifier may be any identifier such as a city identifier, a state identifier, a house number, a street name, a zip code, and an area code, etc. Similarly, a user identifier distinguishes one user from another user. The user identifier may be any identifier such as a name, e-mail address, credit card number, phone number, etc.

For the purpose of transmitting web pages, appliance selection data, data indicative of available repair time slots, and other data to the client devices 102 and/or the repair providers 106 via the wide area network 108, the repair scheduling server 104 includes a network transmitter 404. The network transmitter 404 is operatively coupled to the network 108 in a well know manner. For example, the network transmitter 404 may also be an Ethernet interface circuit electrically coupled to the Internet via an Ethernet cable.

Preferably, appliance selection data is transmitted in response to receiving an appliance selection request message. Appliance selection data facilitates identification of one or more appliances in need of repair. For example, the appliance selection data may include web page data which in turn includes a plurality of appliance model numbers. See FIGS. 7-15. The plurality of model numbers may be retrieved from a purchase history database 316 which includes model numbers associated with previous purchases by the current user. Alternatively, the user may enter one or more model numbers into an input box, and/or the user may search for model numbers using a query box. Of course, a person of ordinary skill in the art will readily appreciate that any appliance identifier, not just a model number, may be used. For example, the appliance selection data may include a digital picture of an appliance. In such an instance, the appliance identifier may be user selection data associated with the digital picture, such as a checkbox indicator.

For the purpose of determining available repair time slots based on the appliance identifier and the geographical identifier, the repair scheduling server 104 includes a scheduling module 408. Preferably, the scheduling module 408 is operatively coupled to the decoder 406, a database interface module 410, and the network transmitter 404. Preferably, the scheduling module 408 queries an appliance repair database 314 for a particular appliance repair provider associated with the appliance identifier and/or the geographical identifier. In one embodiment, the appliance repair database 314 also includes time slot data indicative of the particular appliance repair providers availability. In such an instance, the time slot data is preferably updated by the appliance repair providers. Alternatively, the network transmitter may transmit a request to the particular appliance repair provider. Subsequently, the scheduling module 408 may receive schedule data from the particular appliance repair provider via the network receiver 402 and the message decoder 406.

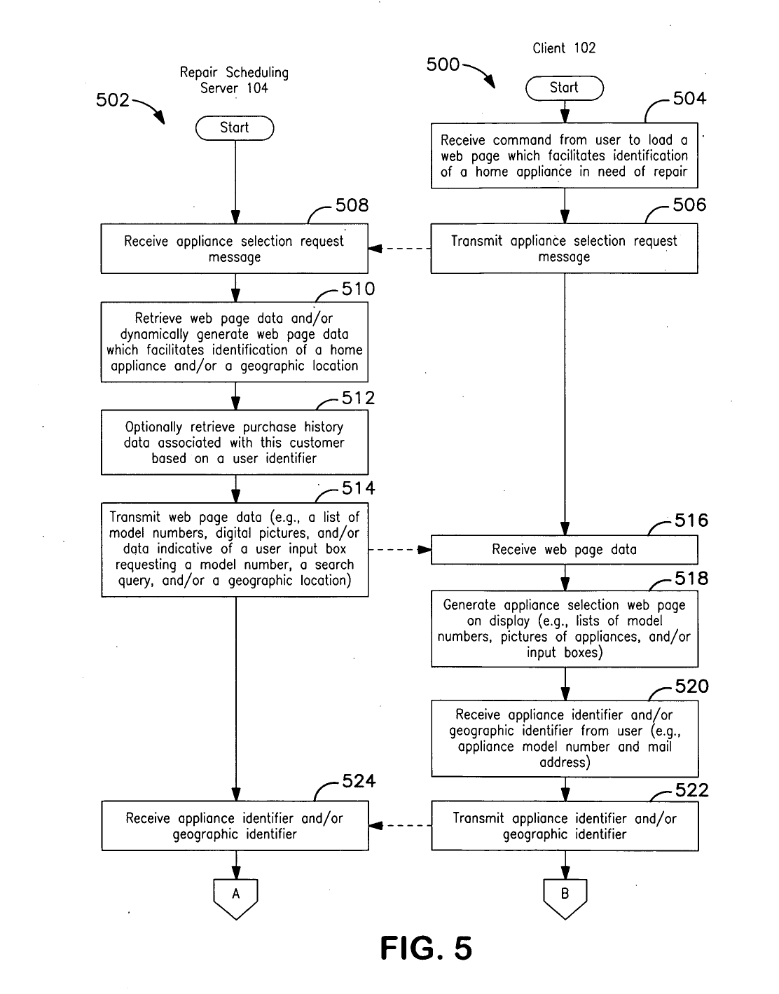

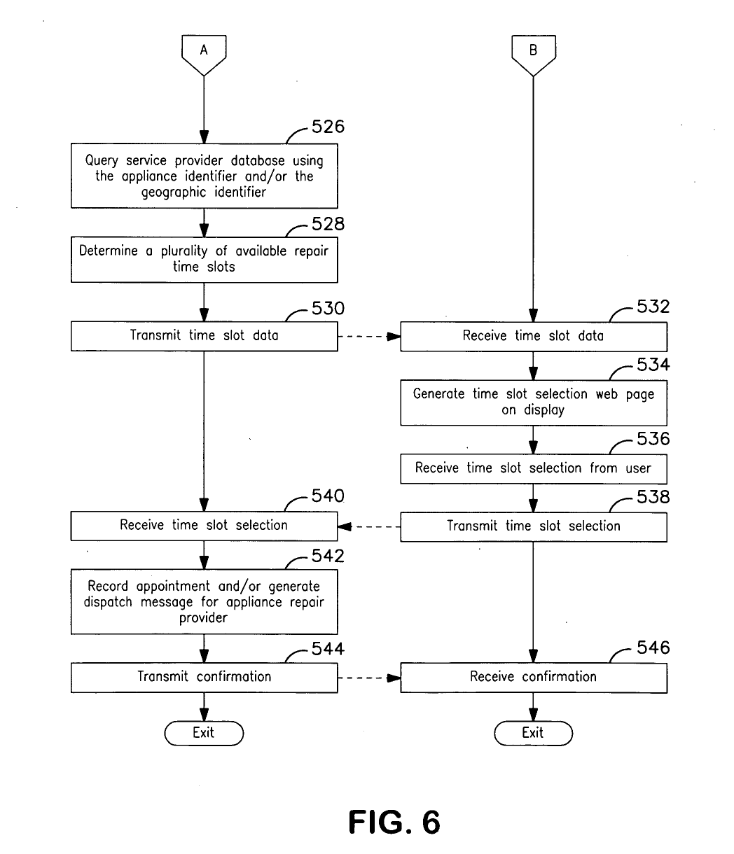

A flowchart of a process for scheduling an in-home appliance repair service is illustrated in FIG. 5 and FIG. 6. Preferably, the process is embodied in two software programs. One of the software programs 500 is preferably stored in the client memory 208 and executed by the client CPU 208 in a well known manner. The other software program 502 is preferably stored in the repair scheduling server memory 308 and executed by the server CPU 304 in a well known manner. However, some or all of the steps of the programs 500, 502 may be performed manually and/or by another device. Although the programs 500, 502 are described with reference to the flowchart illustrated in FIG. 5, a person of ordinary skill in the art will readily appreciate that many other methods of performing the acts associated with programs 500, 502 may be used. For example, the order of many of the steps may be changed without departing from the scope or spirit of the present invention. In addition, many of the steps described are optional.

Generally, program 500 receives inputs from a user via a client device 102. The inputs are used to identify one or more home appliances in need of repair. For example, the user may have a clogged dishwasher. Data identifying the appliance is then transmitted to the repair scheduling server 104. The repair scheduling server program 502 then determines a plurality of available repair time slots and transmits a list of choices to the client device 102 for display. The available repair time slots may depend on the type of appliance, the brand of the appliance, the particular model, the user's identify, and/or the geographical location of the appliance. Preferably, time slots are dynamically determined in cooperation with a plurality of service providers. Once the user selects a timeslot, the service is confirmed and scheduled.

The process begins when program 500 receives a command from a user to load a web page (or any other type of information display) which facilitates identification of a home appliance in need of repair (step 504). See FIG. 7. The client device 102 then transmits an appliance selection request to the repair scheduling server 104 (step 506). Preferably, the appliance selection request is a request for a web page which facilitates identification of the home appliance in need of repair.

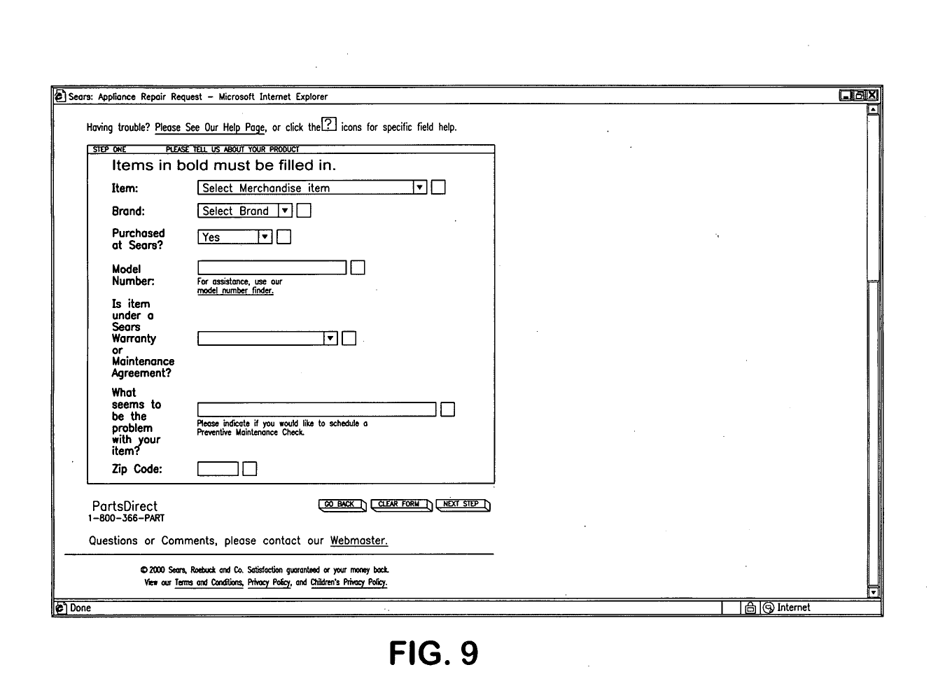

Once the scheduling server 104 receives the appliance selection request (step 508), the scheduling server 104 retrieves web page data which facilitates identification of the home appliance (step 510). See FIGS. 7-15. Of course, a person of ordinary skill in the art will readily appreciate that some or all of the web page data may be dynamically generated. In addition, data for generating displays at the client device other than web page data may be used. Further, the data may also prompt the user for a geographical location (e.g., address, zip code, etc.) See FIG. 9. Still further, the program 502 may retrieve a list of appliances previously purchased by this user based on a user identifier such as the user's name, credit card number, phone number, or cookie data (step 512). If a list of previously purchased appliances is retrieved, the list may be subsequently displayed to the user to conveniently facilitate selection of the particular appliance in need of repair.

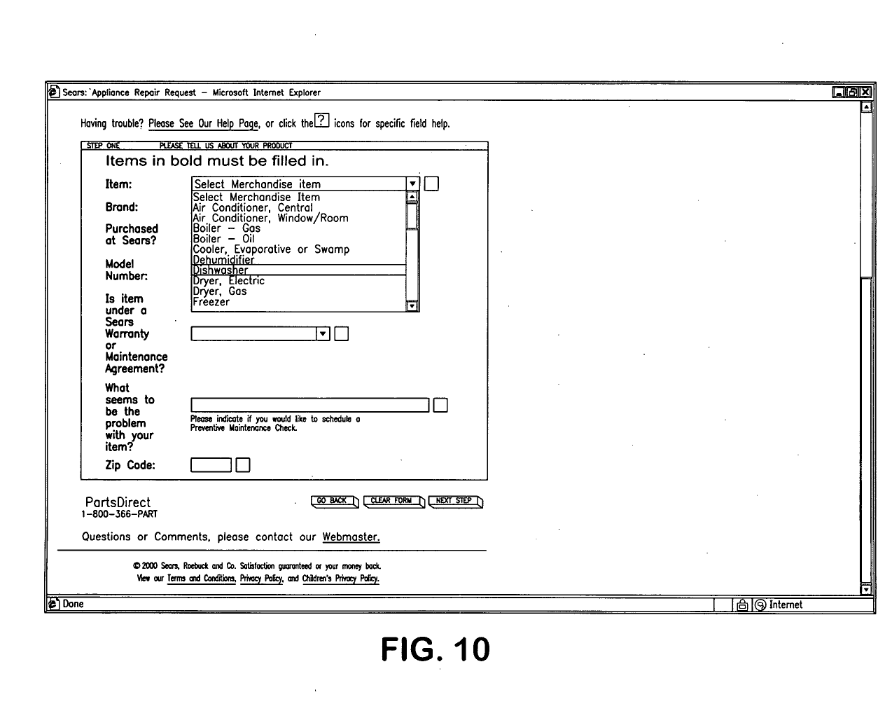

Once the web page data (or other data) is retrieved and/or generated, the sever 104 transmits the data to the client device 102 (step 514). By way of example, the transmitted data may include a list of model numbers, digital pictures of appliances, code indicative of a user input box requesting a model number or other appliance identifier, code indicative of a search query box, and/or code indicative of a request to input a geographic identifier. See FIGS. 10-14.

After receiving the data from the scheduling server 104 (step 516), the client device 102 generates a web page (or other display) based on the received data (step 518). The web page helps the user identify the appliance in need of repair. For example, the web page may include lists of model numbers, pictures of appliances, data input boxes, etc. See FIG. 1014. In response, the user identifies the appliance in need of repair (e.g., enters or selects an appliance model number) and preferably identifies his/her geographical location (e.g., enters his/her postal address) (step 520). The appliance identifier and/or the geographical identifier are then transmitted to the repair scheduling server 104 (step 522).

Once the scheduling server 104 receives the appliance identifier and/or the geographical identifier from the client device 102 (step 524), the scheduling server 104 queries the service provider database 314 using the appliance identifier and/or the geographical identifier as a search key (step 526). In response to the query, the service provider database 314 returns a plurality of available time slots and/or electronic contact information for one or more service providers (step 528). The electronic contact information may be used to query additional databases associated with the appliance repair service providers. The available time slots are the transmitted to the client device 102 (step 530).

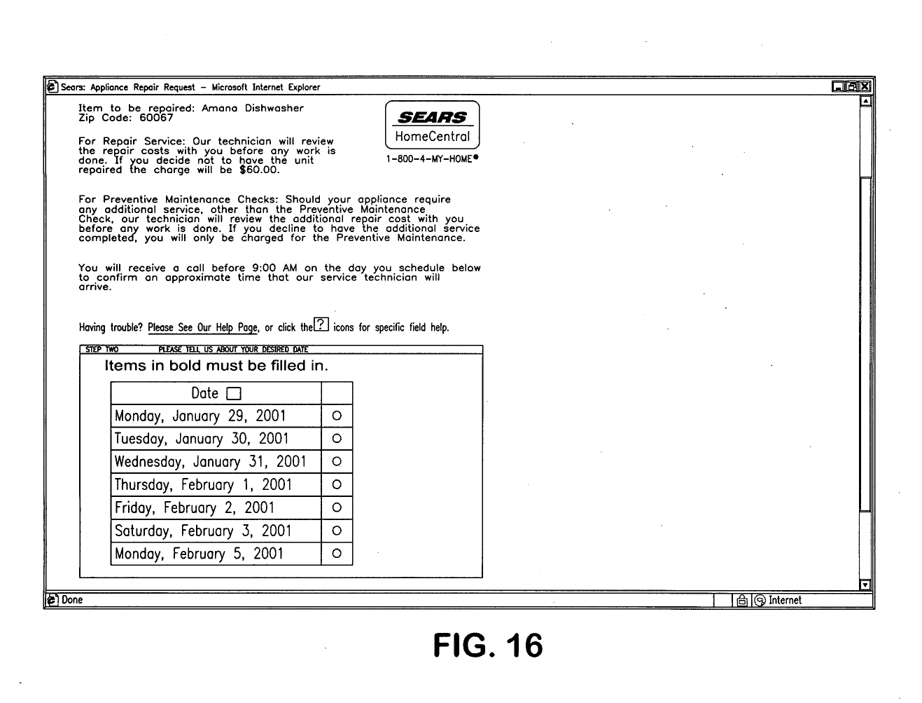

After receiving the data from the scheduling server 104 (step 532), the client device 102 generates a web page (or other display) based on the received data (step 534). The web page helps the user select a time slot (step 536). See FIG. 16. The selected time slot is then transmitted to the scheduling server 104 (step 538).

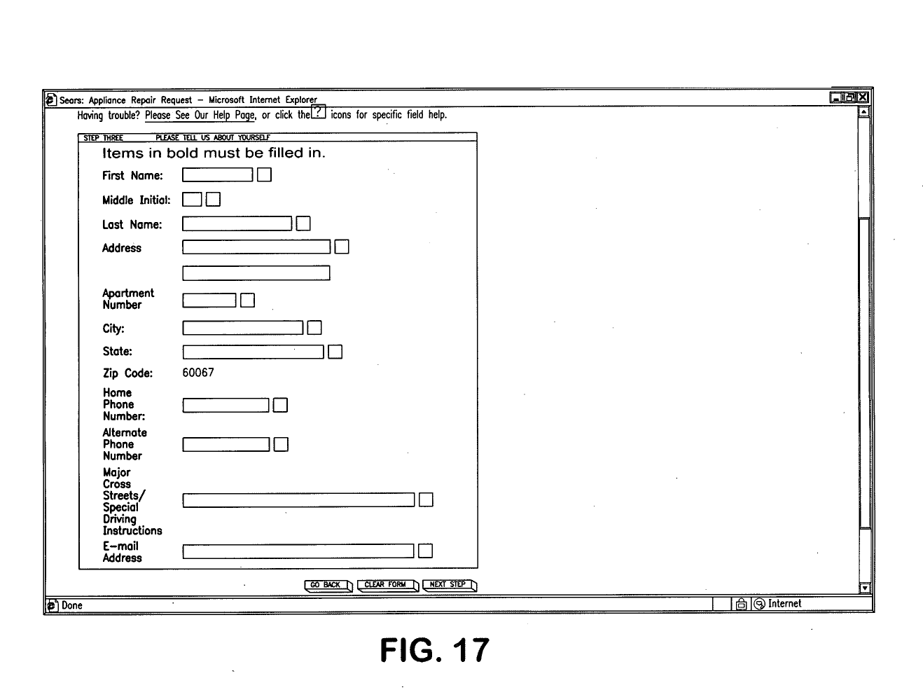

Once the scheduling server 104 receives the time slot selection from the client device 102 (step 540), the scheduling server 104 may request additional contact information form the user. See FIG. 17. Once the scheduling server 104 receives all the necessary information, the scheduling server 104 records an appointment and/or generates a dispatch message for the appliance repair service provider (step 542). Preferably, a confirmation message is then transmitted to the client device for display as a web page and/or an e-mail message (steps 544 and 546).

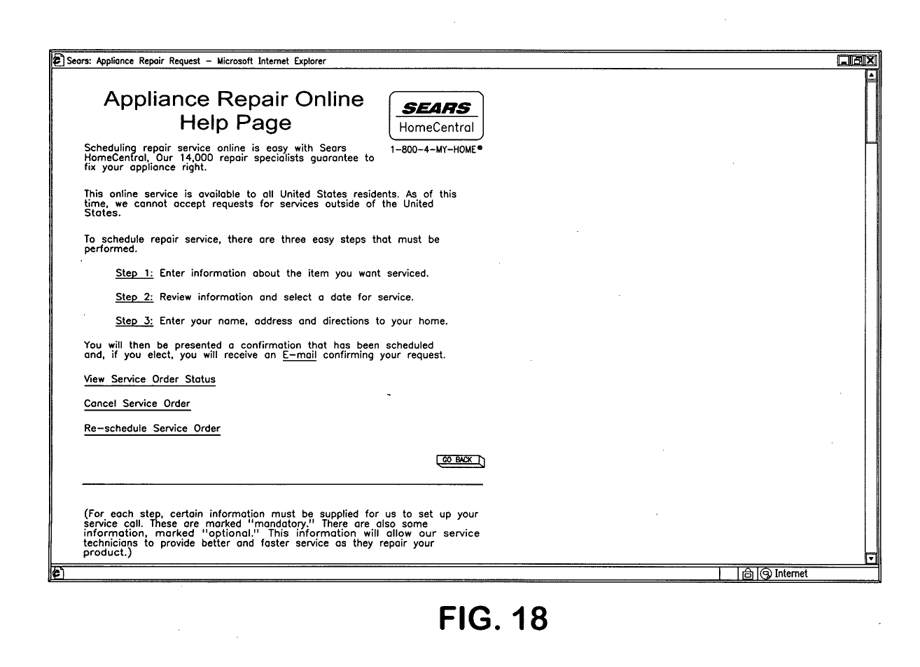

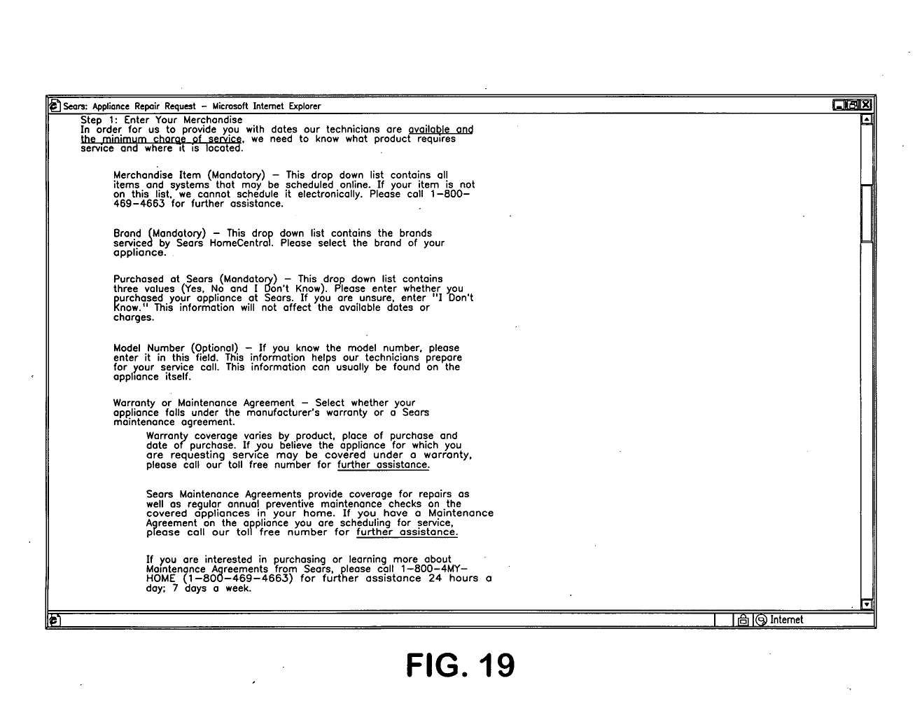

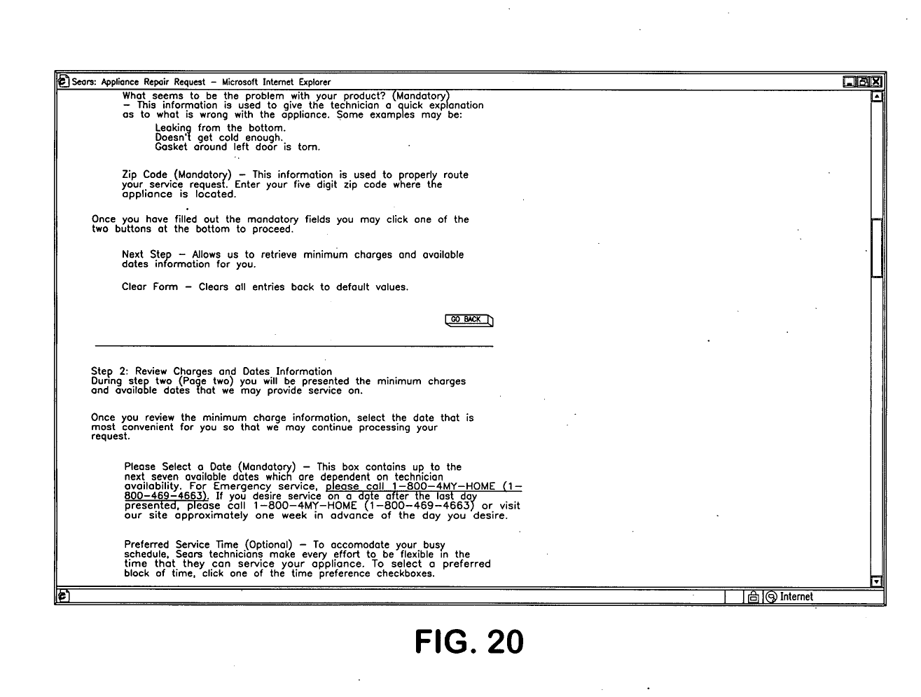

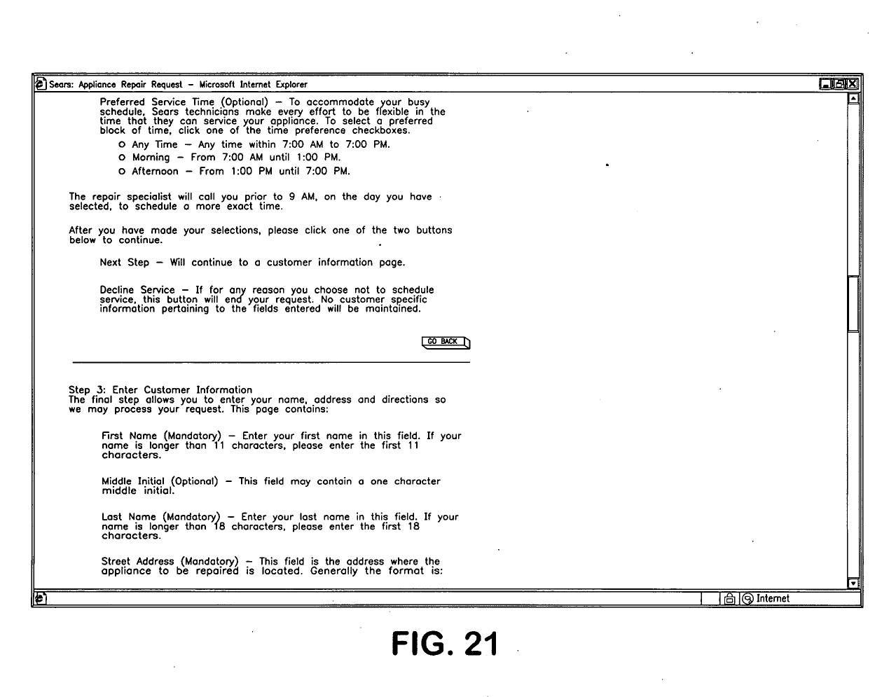

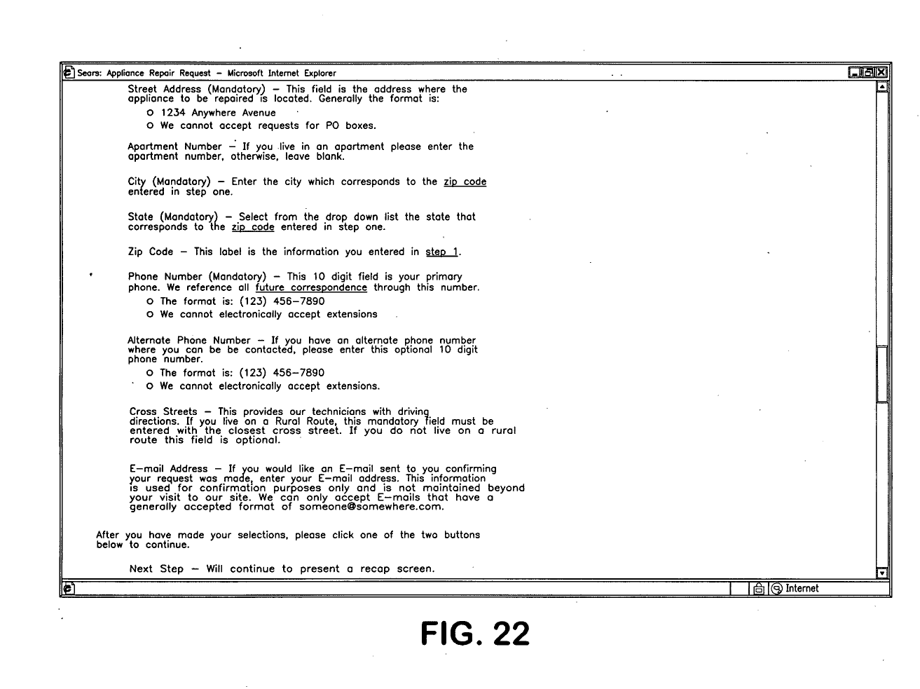

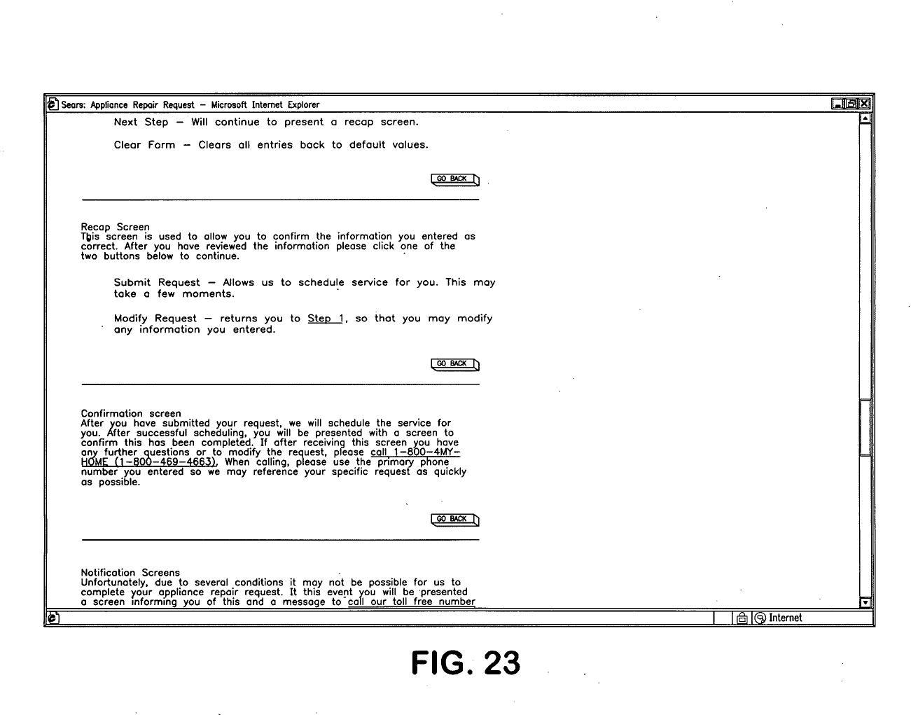

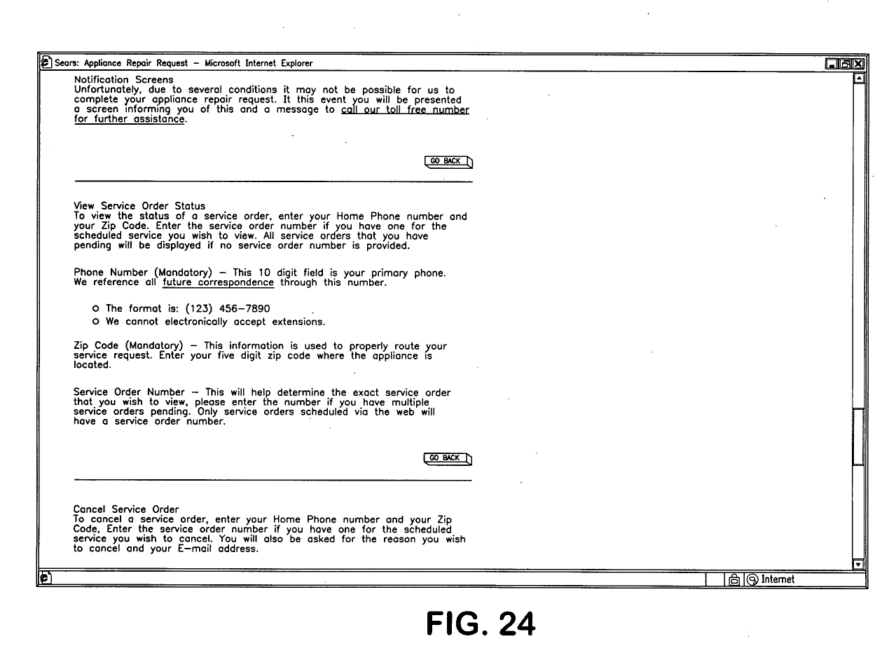

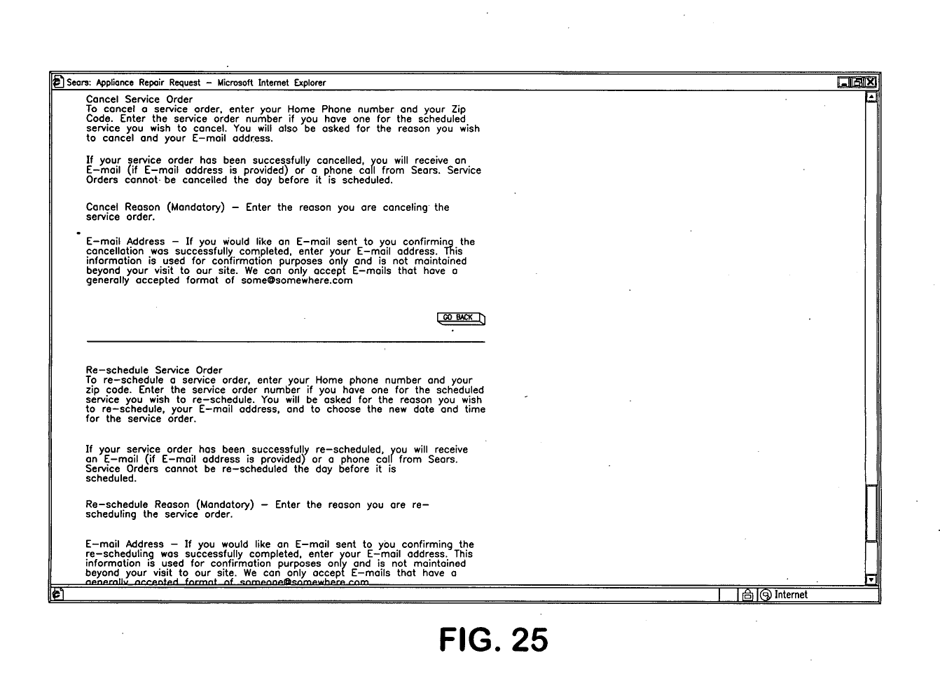

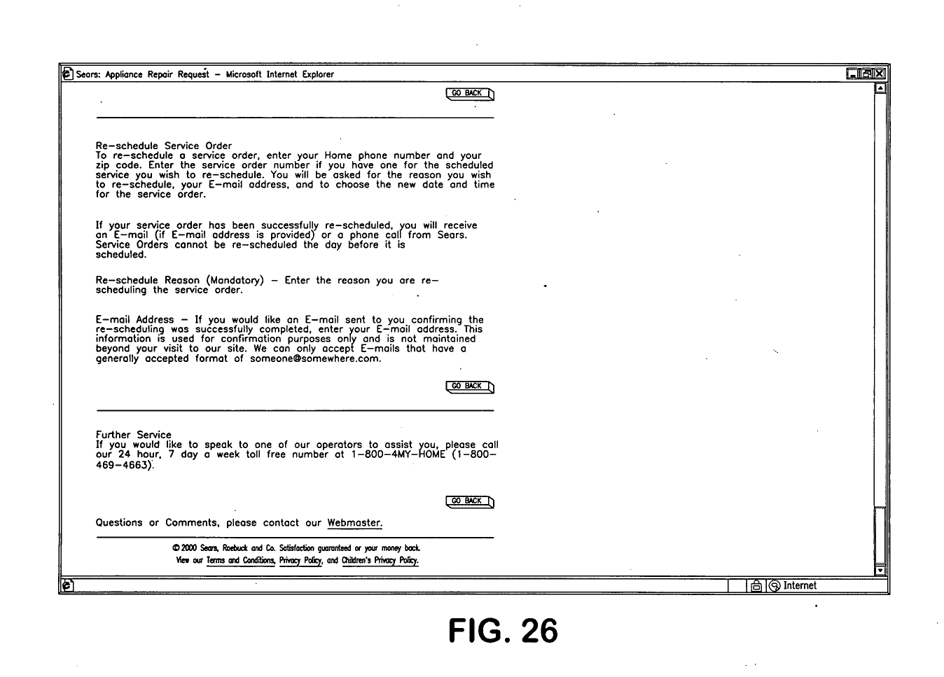

At any time, the user may request help information. Preferably, the help information is displayed at the client device 102 in the form of one or more web pages. See FIGS. 18-26. Although the example web pages provided herein describe certain data fields as “mandatory,” a person of ordinary skill in the art will readily appreciate that many data fields may be made optional within the scope and spirit of the present invention.

In summary, persons of ordinary skill in the art will readily appreciate that a method and apparatus for scheduling an in-home appliance repair service has been provided. Customers of systems implementing the teachings described herein can enjoy quick access to a wide variety of repair service providers familiar with specific the customer's repair needs without the need for phone calls. In addition, a variety of repair time slots are selectable twenty-four hours a day.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A system for scheduling an in-home appliance repair service by a customer, comprising:
an appliance repair database storing repair time slot data dynamically updated by multiple appliance repair providers; and
a scheduling server in communication with the appliance repair database, the scheduling server using at least one of an appliance identifier and a geographical identifier provided by the customer to obtain from the appliance repair database multiple repair time slots determined to be available to the customer for scheduling the in-home appliance repair service wherein the scheduling server causes data indicative of the multiple available repair time slots to be communicated from the server device to a client device via a wide area network and wherein the scheduling server uses a selection of one of the multiple available repair time slots communicated from the client device via the wide area network to generate a dispatch message to a one of the multiple appliance repair providers that is associated with the selected one of the multiple available repair time slots to thereby schedule the in-home appliance repair service by the one of the multiple appliance repair providers within the selected one of the multiple available repair time slots.

2. The system as recited in claim 1, wherein the scheduling server provides to the client device a first web page by which the customer provides to the scheduling server the appliance identifier.

3. The system as recited in claim 2, wherein the scheduling server provides to the client device a second web page by which the customer provides to the scheduling server the selection of one of the multiple available repair time slots.

4. The system as recited in claim 3, wherein the scheduling server records an appointment indicative of the in-home appliance repair service to be provided by the one of the multiple appliance repair providers within the selected one of the multiple available repair time slots.

5. The system as recited in claim 1, wherein the scheduling server exchanges communications with the client device using a hypertext transport protocol (HTTP) protocol.

6. The system as recited in claim 2, wherein the first web page comprises a list of model numbers from which the appliance identifier is provided to the scheduling server.

7. The system as recited in claim 6, comprising a purchase history database in communication with the scheduling server wherein the scheduling server uses a user identifier provided by the customer to retrieve from the purchase history database the list of model numbers.

8. The system as recited in claim 2, wherein the first web page comprises a pictures of appliances from which the appliance identifier is provided to the scheduling server.

9. The system as recited in claim 1, wherein the geographical identifier comprises at least one of a city identifier, a state identifier, a house number, a street name, a zip code, and an area code.
